(19) United States
(12) Patent Application Publication
(10) Pub. No.: US 2011/0167689 A1
(43) Pub. Date: Jul. 14, 2011

(54) COVERT IDENTIFICATION PATCH

(76) Inventor: Timothy D.F. FORD, Beaconsfield (CA)

(21) Appl. No.: 12/722,171

(22) Filed: Mar. 11, 2010

Related U.S. Application Data
(60) Provisional application No. 61/159,306, filed on Mar. 11, 2009.

(51) Int. Cl. G09F 13/20; G09F 21/04; G09F 7/04; G09F 7/12; G09F 7/18

(52) U.S. Cl. 40/542

(57) ABSTRACT

An identification patch adapted to be attached to an object for its identification and method. The patch comprises a first area of material radiating within a first infrared band detectable by a first device operating in said first infrared band and a second area of material radiating within a second infrared band detectable by a second device operating in said second infrared band. The combination of the first and second areas of material forms a discernable pattern detectable when using a selected one of said devices yet covert to the naked eye.

A covert identification patch for a vehicle having a roof and method. The patch comprises a frame having a first surface and a second surface the frame dimensioned and having an external characteristic to approximate that of a sunroof, a first material on the first surface wherein the first material radiates electromagnetic radiation within a first band undetectable to the naked eye, and an adhesive for attaching the frame to the roof.

### CROSS REFERENCE TO RELATED APPLICATIONS

This application claims benefit, under 35 U.S.C. §119(e), of U.S. provisional application Ser. No. 61/159,306, filed on Mar. 11, 2009. This document above is incorporated herein in its entirety by reference.

### FIELD OF THE INVENTION

The present invention relates to a covert identification patch.

### BACKGROUND OF THE INVENTION

During combat situations and particularly during covert nighttime operations, friendly forces are currently typically identified by securing an identification patch to the uniform of the military personnel in order to prevent the occurrence of serious injury or death resulting from friendly fire. Such a patch typically comprises an infrared reflecting material, which is generally non-reflective to impingement of visible light yet strongly reflects infrared wavelengths. As a result, an observer viewing the scene through special imaging equipment, such as night vision goggles, sees a bright image corresponding to the identification patch, thus alerting the observer to the presence of a member of the friendly forces.

However, such identification patches are typically detectable through one type of imaging equipment only. Also, due to low visibility conditions and the fact that only a small portion of a person is visible due to obstructions, identification of objects or forces as friend or foe becomes difficult and often remains a judgment call to the observer as similarities in uniforms between factions often provides little to distinguish between forces on one side from those on another side.

Additionally, law enforcement and military vehicles are often identified using a number or the like on the roof of the vehicle. However, these readily identify the vehicles as such and in cases where the nature of the vehicles use requires covert operation, are inadequate.

What is therefore needed, and an object of the present invention, is an improved covert identification devices and methods, which allow for fast, accurate and secure identification of various objects in covert and combat situations.

### SUMMARY OF THE INVENTION

In order to address the above and other drawbacks, there is provided in accordance with the present invention an identification patch comprising a first area of material for radiating electromagnetic radiation within a first band undetectable to the naked eye, and a second area of material for radiating electromagnetic radiation within a second band undetectable to the naked eye, wherein the first area of material and the second area of material are combined to form a discernable pattern.

There is also provided a method of covert identification of an object comprising providing a material combination comprising a first area of material and a second area of material to form a discernable pattern, wherein first area of material radiates electromagnetic radiation within a first infrared band and a second area of material radiates electromagnetic radiation within a second infrared band, and attaching the material combination to the object.

Additionally, there is provided a method of covert identification of a vehicle having a roof comprising preparing a patch comprising a first material wherein the first material radiates electromagnetic radiation within a first infrared band, the patch being dimensioned and having an external characteristic to approximate that of a sunroof, and attaching the patch to the roof in a position approximately the same as to that where a sunroof would be otherwise positioned.

Also, there is provided a covert identification patch for a vehicle having a roof, comprising a frame having a first surface and a second surface the frame dimensioned and having an external characteristic to approximate that of a sunroof, a first material on the first surface wherein the first material radiates electromagnetic radiation within a first band undetectable to the naked eye, and an adhesive for attaching the frame to the roof.

### BRIEF DESCRIPTION OF THE DRAWINGS

In the appended drawings:

FIG. 1 is a perspective view of a covert identification patch in accordance with an illustrative embodiment of the present invention;

FIG. 2A is a front view of the patch of FIG. 1 viewed through an imaging device in accordance with an illustrative embodiment of the present invention;

FIG. 2B is a front view of the patch of FIG. 1 viewed through an imaging device in accordance with an alternative illustrative embodiment of the present invention;

FIG. 3 is a sectional view of a covert identification patch in accordance with an alternative illustrative embodiment of the present invention; and

FIG. 4A is a perspective view of a panel in accordance with a second alternative illustrative embodiment of the present invention;

FIG. 4B is a cross sectional view of the panel along IV-IV in FIG. 4A;

FIG. 5 is a perspective view of an automobile equipped with the panel of FIG. 4A;

FIGS. 6A through 6C provide examples of designs for identification patches in accordance with illustrative embodiments of the present invention.

### DESCRIPTION OF ILLUSTRATIVE EMBODIMENTS

The present invention is illustrated in further details by the following non-limiting examples.

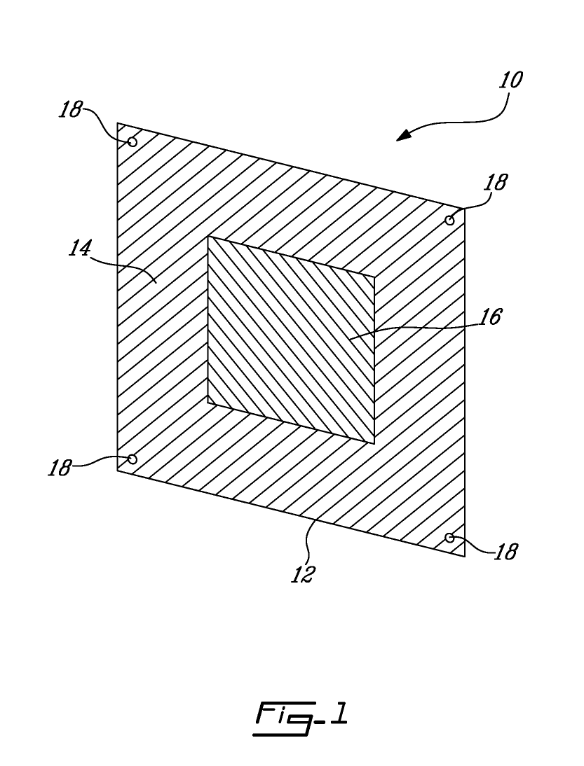

Referring now to FIG. 1, a covert identification patch, generally referred to using the reference numeral 10, will now be described. The patch 10 comprises a front face 12 designed for visibility by an observer at a distance. The front face in turn 12 comprises a first base material 14 radiating (that is, emitting, absorbing and or reflecting) electromagnetic radiation in a first band of wavelengths not visible to the naked eye and a second material 16 radiating electromagnetic radiation in a second band of wavelengths not visible to the naked eye attached to the first material 14 for creating a pattern.

Still referring to FIG. 1, the materials 14, 16 illustratively form a patch having a generally rectangular shape and are manufactured of lightweight flexible fabric, which is durable and meets military specifications. As the second material 16 is illustratively overlayed on the first material 14, the second material 16 has a size smaller than that of the first material 14. The thus formed patch 10 may be used for marking of friendly forces (e.g. when worn as a badge), vehicles, and positions to allows observation thereof and prevent fratricide, namely the killing of friendly forces by other friendly forces. The patch 10 may also be used during training and combat operations for marking of lanes, routes, obstacles, unit boundaries, or the like or, as will be discussed in more detail below, for covertly identifying vehicles engaged in law enforcement activities.

Still referring to FIG. 1, rings or eyelets as in 18 are illustratively provided for the attachment of the patch 10 using attachment means, such as a cord, rope, straps, or the like (none shown) to objects, which hold the patch 10 in place, for example poles (not shown) for keeping the patch 10 in an upright position. The rings as in 18 (or any other suitable fastening method, such as sewing or Velcro™ or the like) may also enable attachment of the patch 10 to the helmet or the uniform of a soldier (not shown) when the patch 10 is worn as a badge for enabling friend-or-foe identification.

Still referring to FIG. 1, the second material 16 is illustratively attached to the first material 14 using a conventional fastening method, such as gluing, stitching, or the like. Alternatively, a cut-out (not shown) may be formed in the first material 14 for inserting the second material 16 therein. Advantageously, the infrared reflective material 16 illustratively has no electrical or other power device attached thereto for enabling distinguishing thereof, thus alleviating the need for carrying heavy power equipment (e.g. batteries or generators), which may be detectable by enemy forces. Materials thus attached 14, 16 illustratively form an identification pattern that can be easily recognized by friendly forces with the use of appropriate visualising apparatus. The shape, size and pattern of the materials 14, 16 may indeed differ depending on the information to be conveyed and on the distance to be ranged. Indeed, different configurations (e.g. rectangular or square pattern, as illustrated in FIG. 1, circular pattern, or triangular pattern with a triangle pointing upwards, downwards, or sideways according to the information to be conveyed, flags, coats of arms, symbols of rank or the like) may be assigned to different friendly personnel and/or units.

Still referring to FIG. 1, the patch 10 is illustratively configured so that light is selectively reflected by the materials 14, 16 to create the desired pattern and for this purpose, the first material 14 is illustratively a thermal reflective material whereas the second material 16 is a near infrared reflective material. The first material 14 thus radiates electromagnetic radiation in the thermal imaging or long-wavelength infrared region, i.e. wavelengths between about 8 and 15 μm. The first material 14 is therefore visible through thermal imaging devices, such as thermal imaging cameras, or other optically assisted viewing devices (not shown), which operate in the thermal imaging area of the spectrum and are adapted to obtain a picture of an observed scene based on thermal emissions only and requiring no external light or thermal source.

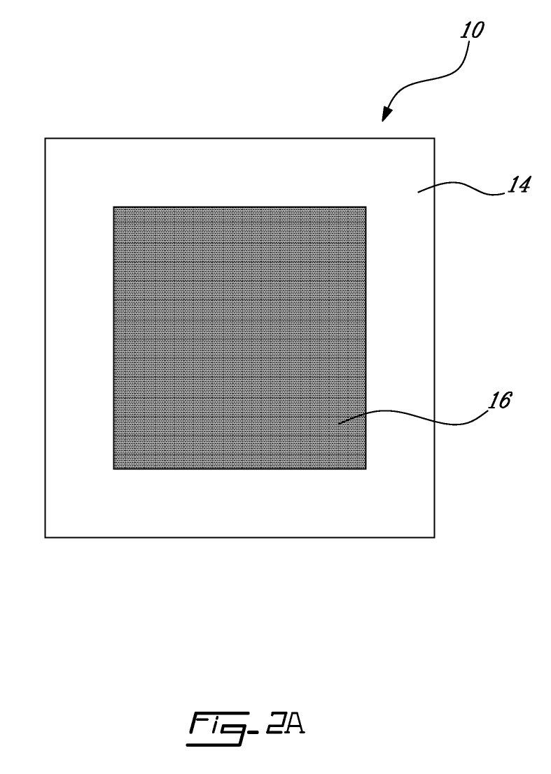

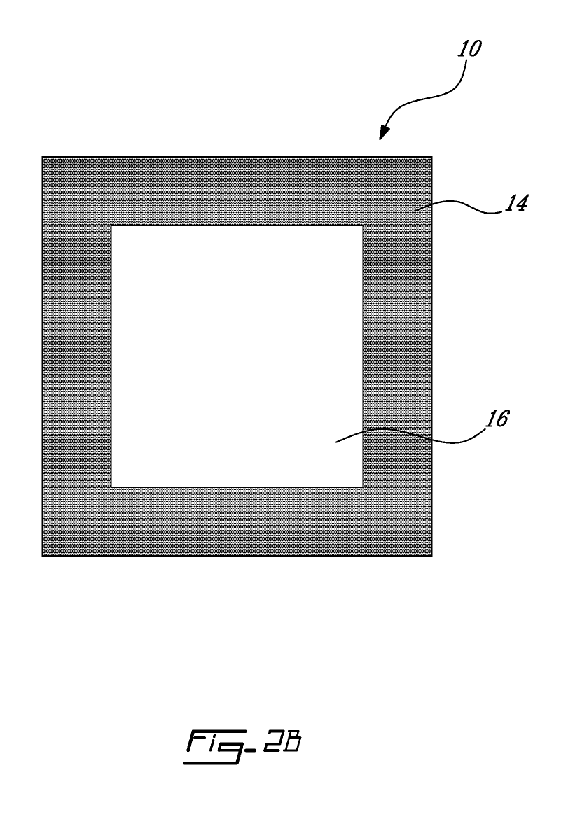

Still referring to FIG. 2, the second material 16, on the other hand, emits radiation in the near-infrared portion of the electromagnetic spectrum, i.e. wavelengths between about 800 nm and 1 mm, but is substantially non reflective to wavelengths in the visible light portion of the electromagnetic spectrum, thus making it difficult for the naked (or simply aided, e.g. with binoculars) eye to distinguish the material 16 under either daytime or nighttime conditions. In particular, the selective reflectivity of the material 16 makes the latter visible through image intensifiers (not shown), e.g. night vision devices such as night vision goggles (NVGs) using a built-in infrared illuminator or the like, which are sensitive to the near-infrared area of the spectrum and are typically used by military personnel. The use of a patch of near-infrared reflective material 16 thus causes an observer viewing the scene through an image intensifier to see a bright portion on a darker background, with the bright portion in accordance in accordance with the pattern or design (such as the flag or other designs as described above).

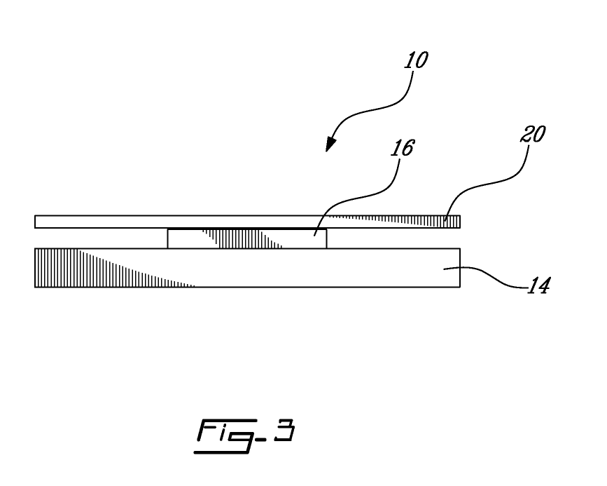

Referring now to FIG. 2A and FIG. 3B, the pattern formed by the overlaid materials 14, 16, can therefore be distinctly viewed at a distance using both thermal imaging devices and image intensifiers whereas the patch 10 will generally remain unremarkable to the naked eye. The patch 10 is advantageously camouflaged from normal view. A person of ordinary skill in the art will now understand that this can help prevent unwanted persons from distinguishing and becoming alerted to so equipped assets and forces. Indeed, as both thermal and infrared spectrums are provided on the same patch 10 and form a desired identification pattern, the latter can be viewed either using thermal imaging devices or image intensifiers.

Still referring to FIG. 2A and FIG. 2B, when observing the patch 10 using thermal imaging devices, the observer will illustratively view a bright pattern corresponding to the shape of the first material 14 with a center dark portion corresponding to the shape of the second material 16, which is not visible through the thermal imager (see FIG. 2A). The identification pattern of the patch 10 may alternatively be viewed using image intensifiers, in which case, the observer will view a bright portion corresponding to the shape of the second material 16 highlighted around a darker background corresponding to the shape of the non-visible first material 14 (see FIG. 2B). In this manner, the presence of the patch 10, and in particular the pattern provided thereon, can be securely and accurately detected by a person observing through thermal imaging devices or image intensifiers in order to quickly distinguish forces that are friendly whereas hostile forces are distinguished by an absence of the patch 10.

Referring now to FIG. 3, in an alternative illustrative embodiment an additional layer of material 20 (such as a film or coating) may be positioned over the materials 14, 16 of the patch 10 at the front face (reference 12 in FIG. 1) for restricting the light reflected by the materials 14, 16. In this manner, it becomes possible to design the patch 10 so that it is highly directional and viewable directly from the front or the top thereof and not from the sides whereas in other embodiments, it may be desirable to tailor the design of the patch 10 so that the latter can be viewed from all angles. For example, an anti-glare film may be used to restrict reflections from the near-infrared reflective material 16 so that the patch 10 can only be seen by an observer (aided by special equipment, as discussed herein above) placed immediately in front or on top of the patch 10.

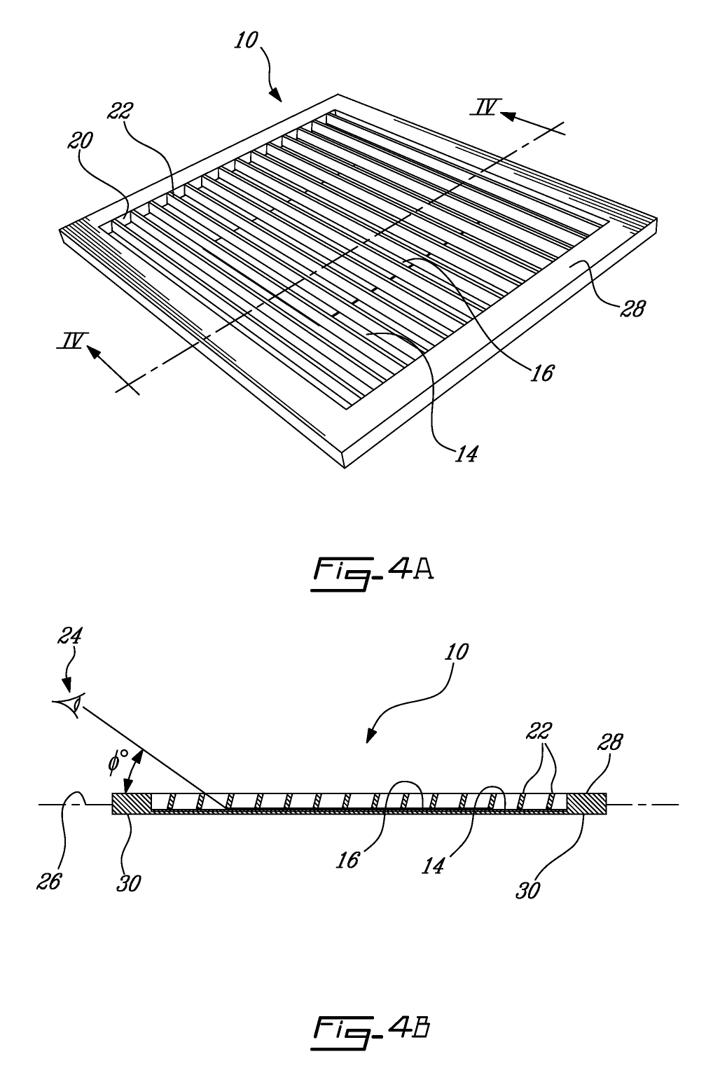

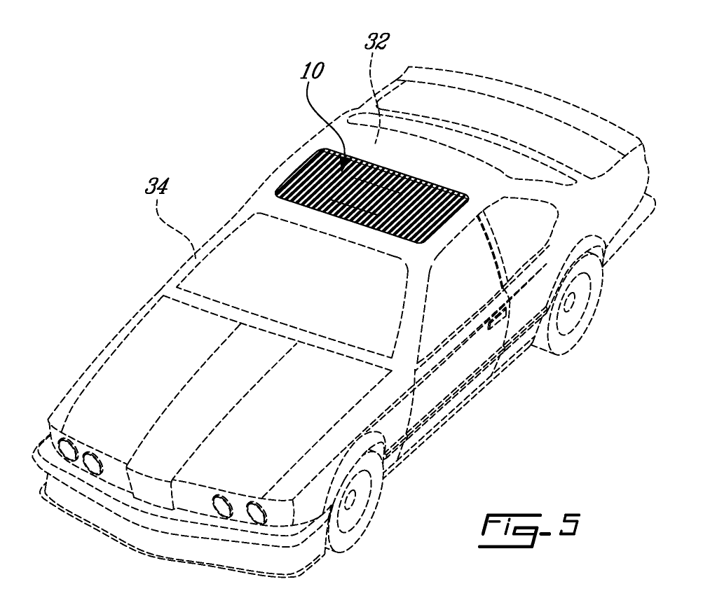

Referring now to FIG. 4A, in a second alternative illustrative embodiment the additional layer of material 20 can be a thick open weave cloth, such as cheesecloth or the like. Referring to FIG. 4B, in this regard the material provides a series of raised ridges as in 22 which limit viewing of the first material 14 and the second material to one were a user 24 is positioned at some angle φ above the plane 26 within which the panel 10 lies. Additionally, the panel may further include a relatively thick and rigid frame 28 manufactured from plastic or the like and into which a plurality of magnets as in 30 are moulded or otherwise attached. Alternatively a flexible magnetic sheet (not shown) can be moulded or otherwise bonded to the underside of the panel 10.

Referring now to FIG. 5 in addition to FIGS. 4A and 4B using the magnets as in 30 the panel 10 can be attached to metallic objects such as the roof 32 of an automobile 34. In this regard the look of the panel 10 in terms of sizing, colour and shape is selected to be similar or the same as those of a tinted sunroof, and would be typically positioned similarly. Such a panel 10 is foreseen for use, for example, on unmarked police cars, which would allow the car to be clearly identified from above by a suitably equipped individual in a helicopter or airplane or the like while retaining the unmarked nature of the car.

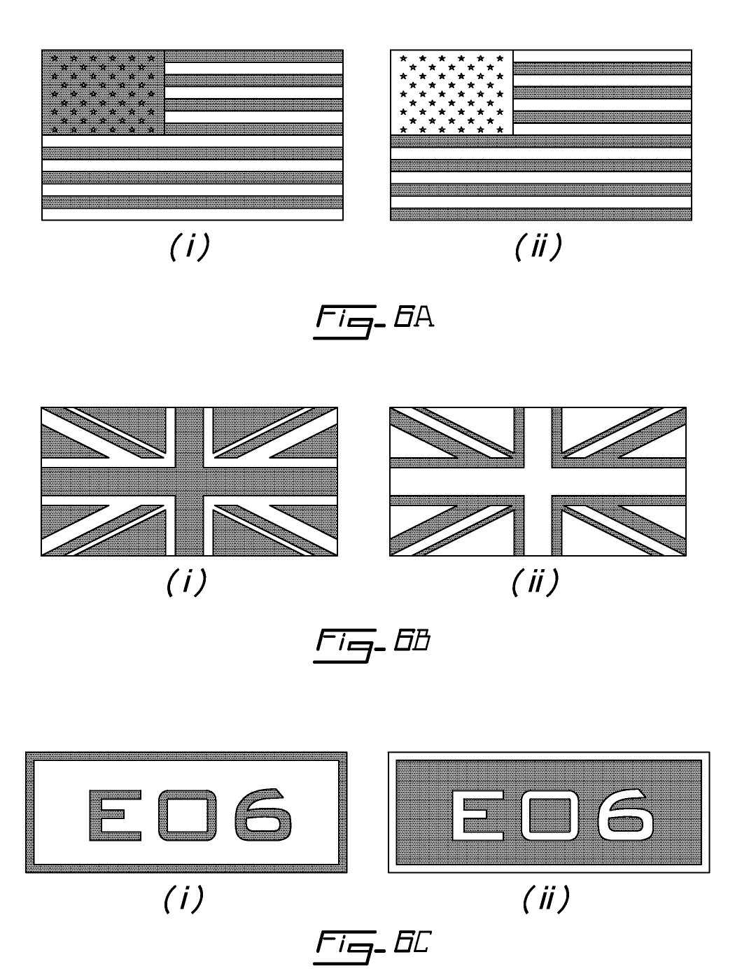

Referring now to FIGS. 6A through 6C examples of possible identification panels are provided as would be viewed through (i) a thermal imaging device and (ii) a night vision device. Of note is that FIGS. 6A and 6B would typically be relatively small and used as an identification patch attached to a person. FIG. 6C provides a larger identification panel as might be attached to a vehicle or the like, such as the mock sunroof as discussed hereinabove.

Although the present invention has been described hereinabove by way of specific embodiments thereof, it can be modified, without departing from the spirit and nature of the subject invention as defined in the appended claims.

We claim:

1. An identification patch comprising:
a first area of material for radiating electromagnetic radiation within a first band undetectable to the naked eye; and
a second area of material for radiating electromagnetic radiation within a second band undetectable to the naked eye;
wherein said first area of material and said second area of material are combined to form a discernable pattern.

2. The identification patch of claim 1, wherein said first area of material radiates electromagnetic radiation detectable with a first viewing device operating in said first band and said second area of material radiates electromagnetic radiation detectable with a second viewing device operating in said second band.

3. The identification patch of claim 2, wherein said first band comprises a far infrared range of wavelengths detectable by a thermal imaging device operating in said far infrared range and said second band comprises a near infrared range of wavelengths detectable by a night vision device operating in said near infrared range, wherein said areas are combined to form a discernable pattern detectable using a selected one of said thermal imaging device or said night vision device.

4. The identification patch of claim 1, wherein said first area of material is a substantially flat fabric impregnated with a substance for radiating electromagnetic radiation within said first band and said second area of material is a substantially flat fabric impregnated with a substance for radiating electromagnetic radiation within said second band.

5. The identification patch of claim 1, wherein said discernable pattern is formed by the overlay of at least a portion of said first area of material onto said second area of material.

6. The identification patch of claim 1, wherein said discernable pattern is formed by the overlay of at least a portion of said second area of material onto said first area of material.

7. The identification patch of claim 1, wherein said discernable pattern is formed by the insertion of said first area of material into a cut-out portion of said second area of material.

8. The identification patch of claim 1, wherein said discernable pattern is an insignia.

9. The identification patch of claim 1, further comprising a layer of light collimating material positioned overtop of said first and second areas of material for restricting the passage of radiation to a substantially perpendicular angle to said first and second areas of material.

10. The identification patch of claim 9, wherein said light collimating material comprises an anti-glare material.

11. The identification patch of claim 9, wherein said light collimating material comprises a mesh.

12. The identification patch of claim 11, wherein said mesh is fabricated from a layer of cheese-cloth like material.

13. The identification patch of claim 1, wherein the identification patch comprises a fastener for attachment to an object.

14. The identification patch of claim 13, wherein said fastener is selected from the group consisting of an eyelet, stitching and an adhesive or combinations thereof.

15. The identification patch of claim 1, wherein said first and said second layers of material are attached to a frame.

16. The identification patch of claim 15, wherein the object is fabricated from a ferrous metal such as a vehicle and further wherein said frame comprises a plurality of magnets for attachment to the object.

17. The identification patch of claim 1, wherein the object is fabricated from a ferrous metal such as a vehicle and further wherein said first and said second areas of material are overlaid on a flexible magnetic sheet for attachment to the object.

18. A method of covert identification of an object comprising:
providing a material combination comprising a first area of material and a second area of material to form a discernable pattern; wherein first area of material radiates electromagnetic radiation within a first infrared band and a second area of material radiates electromagnetic radiation within a second infrared band; and
attaching said material combination to the object.

19. The method of identification of claim 18, wherein said first area of material radiates electromagnetic radiation within a far infrared range of wavelengths detectable by a thermal imaging device operating in said far infrared range; and said second area of material radiates electromagnetic radiation within a near infrared range of wavelengths detectable by a night vision device operating in said near infrared range; wherein said areas are combined to form a discernable pattern detectable using a selected one of said thermal imaging device or said night vision device.

20. The method of identification of claim 18, further comprising placing a layer of anti-glare material overtop of said first and second areas of material for restricting the passage of said radiation to a substantially perpendicular angle to said first and second areas of material.

21. The method of identification of claim 18, further comprising placing a layer of mesh overtop of said first and second areas of material for restricting the passage of said radiation to a substantially perpendicular angle to said first and second areas of material.

22. The method of identification of claim 21, wherein said mesh is fabricated from a cheesecloth like material.

23. The method of identification of claim 18, wherein said first and said second layers of material are attached to a frame.

24. The method of identification of claim 22, wherein the object is fabricated from a ferrous metal such as a vehicle and further wherein said frame comprises a plurality of magnets for attachment to the object.

25. The method of identification of claim 18, wherein the object is fabricated from a ferrous metal such as a vehicle and further comprising supporting said first and said second areas of material on a flexible magnetic sheet for attachment to the object.

26. A method of covert identification of a vehicle having a roof comprising:
preparing a patch comprising a first material wherein said first material radiates electromagnetic radiation within a first infrared band;
said patch being dimensioned and having an external characteristic to approximate that of a sunroof; and
attaching the patch to the roof in a position approximately the same as to that where a sunroof would be otherwise positioned.

27. The method of covert identification of a vehicle having a roof of claim 26, wherein said patch further comprises a second material wherein said second material radiates electromagnetic radiation within a second infrared band.

28. The method of identification of claim 26, wherein said patch is attached to the roof via at least one magnet.

29. A covert identification patch for a vehicle having a roof, comprising:
a frame having a first surface and a second surface said frame dimensioned and having an external characteristic to approximate that of a sunroof;
a first material on the first surface wherein said first material radiates electromagnetic radiation within a first band undetectable to the naked eye; and
an adhesive for attaching said frame to the roof.

30. The covert identification patch of claim 29, wherein said patch further comprises a second material and wherein said second material radiates electromagnetic radiation within a second band undetectable to the naked eye.

31. The covert identification patch of claim 29, further comprising placing a layer of light collimating material overtop of said first material for restricting the passage of said radiation to a substantially perpendicular angle to said first area of material.

32. The covert identification patch of claim 31, wherein said light collimating material is a transparent anti-glare film.

33. The covert identification patch of claim 31, wherein said light collimating material is a mesh.

34. The covert identification patch of claim 33, wherein said mesh is fabricated from a cheesecloth like material.

35. The covert identification patch of claim 29, wherein said adhesive comprises a flexible magnetic sheet attached to said second surface.

36. The covert identification patch of claim 29, wherein said first area of material forms a recognizable pattern.

37. The covert identification patch of claim 36, wherein said recognizable pattern is selected from a group consisting of a number and an insignia.

38. The covert identification patch of claim 29, wherein said first area of material radiates electromagnetic radiation within a far infrared range of wavelengths detectable by a thermal imaging device operating in said far infrared range and said second area of material radiates electromagnetic radiation within a near infrared range of wavelengths detectable by a night vision device operating in said near infrared range, wherein said areas are combined to form a discernable pattern detectable using a selected one of said thermal imaging device or said night vision device.
